(19) United States
(12) Patent Application Publication
(10) Pub. No.: US 2026/0315899 A1
(43) Pub. Date: Oct. 15, 2026

(54) BICYCLE TRAINING SYSTEM

(71) Applicant: Tacx B.V., Oegstgeest (NL)

(72) Inventors: Jelle Haasnoot, Oegstgeest (NL); Martin Smits, Oegstgeest (NL)

(21) Appl. No.: 19/646,659

(22) Filed: Apr. 14, 2026

Related U.S. Application Data
(60) Provisional application No. 63/788,569, filed on Apr. 14, 2025.

(51) Int. Cl. A63B 69/16; A63B 24/00

(52) U.S. Cl. CPC A63B 69/16; A63B 24/0087; A63B 2069/164; A63B 2220/34; A63B 2220/36; A63B 2220/40; A63B 2220/803

(57) ABSTRACT

A bicycle training system comprising a movement platform configured to rest on a support surface and to support a bicycle in an upright manner with respect to the support surface. The movement platform comprises a feedback assembly configured to apply varying levels of force and/or resistance to the bicycle. The bicycle training system additionally includes a motion detection system comprising one or more sensors configured to detect vertical and horizontal motion of the bicycle, of the movement platform, and/or of a user of the bicycle training system. The one or more sensors are configured to generate motion information based on the detected motion. The bicycle training system further includes an electronic controller configured to receive the motion information from the one or more sensors and to control, based on the motion information, the force and/or resistance applied by the feedback assembly to the bicycle across multiple axes.

### RELATED APPLICATION

The present non-provisional patent application claims priority to U.S. Provisional Patent Application Serial No. 63/788,569 filed on Apr. 14, 2025, and entitled “BICYCLE SIMULATOR WITH MOTION DYNAMICS.” The entirety of the above-identified provisional patent application is hereby incorporated by reference into the present non-provisional patent application.

### BACKGROUND

Bicycle trainers are often used by cyclists for training purposes. These trainers allow cyclists to exercise and train while remaining generally stationary, typically indoors. Trainers may include an integrated bicycle (e.g., handlebars, seat, and pedals) or else be configured to attach to a cyclist’s existing bicycle. For example, some trainers include rollers or sliders upon which a cyclist may place the rear wheel of their bicycle. Other trainers apply resistive or magnetic force to the bicycle’s captured rear wheel. And still other trainers, known as “direct-drive” trainers, enable a cyclist to remove the rear wheel of the bicycle frame and directly attach the frame and a portion of the drivetrain of the bicycle such as the chain to the trainer.

Conventional indoor bicycle training systems are capable of simulating a variety of resistance forces in an effort to replicate the experience of outdoor cycling. These resistance forces typically include air resistance, rolling resistance, slope-based resistance, and inertial resistance, among others. In most instances, such resistive forces are applied in a relatively static or only in a semi-dynamic manner, with updates occurring at discrete intervals—often no more than four times per second in flywheel-based trainer systems. As a result, existing trainers fail to fully capture the nuanced and rapidly changing conditions encountered during actual on-road cycling, particularly those related to the rider's real-time body motion and shifting dynamics.

Cycling in real-world outdoor environments involves a complex interplay of dynamic body movements and responsive resistance forces, which are often oversimplified or entirely absent in conventional indoor training systems. For instance, when a cyclist rises from the saddle and jumps on the pedals during a climb, there is an observable increase in vertical force exerted onto the drivetrain and frame. This abrupt application of force typically corresponds to a momentary increase in both incline resistance and rolling resistance as the rider attempts to propel the bicycle upward against gravity. Similarly, when a cyclist performs a forceful pedal stroke while riding downhill or transitioning over a downward bump, the vertical input leads to a temporary acceleration, effectively reducing relative resistance while increasing the system’s inertial response. Without real-time motion detection and adaptive resistance modulation, these nuanced biomechanical behaviors go unrecognized by traditional trainers.

Other forms of rider movement also impact the mechanical profile of a cycling session. For example, when a cyclist pulls backward on the handlebars while climbing or sprinting—causing their body to shift forward relative to the bicycle frame—there is a resultant increase in inertial force that would typically require a corresponding change in resistance to accurately simulate outdoor riding conditions. Conversely, during moments when a rider pushes forward on the handlebars to overcome the dead spot in the pedal stroke, the effective inertial load decreases, as the rider attempts to maintain momentum through a mechanical disadvantage. These subtle shifts in body motion significantly influence the actual riding dynamics and are critical for both performance optimization and biomechanical training fidelity.

### SUMMARY

Embodiments of the present invention relate to a bicycle training system comprising a movement platform configured to rest on a support surface and to support a bicycle in an upright manner with respect to the support surface. The movement platform comprises a feedback assembly configured to apply varying levels of force and/or resistance to the bicycle. The bicycle training system additionally includes a motion detection system comprising one or more sensors configured to detect vertical and horizontal motion of the bicycle, of the movement platform, and/or of a user of the bicycle training system. The one or more sensors are configured to generate motion information based on the detected motion. The bicycle training system further includes an electronic controller configured to receive the motion information from the one or more sensors and to control, based on the motion information, the force and/or resistance applied by the feedback assembly to the bicycle across multiple axes.

Embodiments of the present invention are further directed to a method of training using a bicycle training system. The method comprises a step of providing the bicycle training system that includes a movement platform positionable on a support surface. An additional step includes supporting, with the movement platform, a bicycle in an upright manner with respect to the support surface. The movement platform comprises a feedback assembly configured to apply varying levels of force and/or resistance to the bicycle. An additional step includes detecting, with a motion detection system comprising one or more sensors, motion of the bicycle, motion of the movement platform, and/or motion of a user of the bicycle training system. An additional step includes generating, with the one or more sensors, motion information based on the detected motion. An additional step includes receiving, via an electronic controller, the motion information from the one or more sensors. A further step includes controlling, with the electronic controller based on the motion information, the force and/or resistance applied by the feedback assembly to the bicycle.

This summary is not intended to identify essential features of the present invention, and is not intended to be used to limit the scope of the claims. These and other aspects of the present invention are described below in greater detail.

### BRIEF DESCRIPTION OF THE DRAWINGS

The present invention is described in detail below with reference to the attached drawing figures, in which like numerals represent the same components, and wherein:

FIG. 1 is a left-side elevation view of a prior-art bicycle training system;

FIG. 2 is a left-side perspective view of an improved bicycle training system according to embodiments of the present invention;

FIG. 3 is a rear elevation view of the bicycle training system shown in FIG. 2; and

FIG. 4 is a schematic diagram of a control system for a bicycle training system according to embodiments of the present invention.

The figures are not intended to limit the present invention to the specific embodiments they depict. While the drawings do not necessarily provide exact dimensions or tolerances for the illustrated structures or components, the drawings are to scale with respect to the relationships between the components of the structures illustrated in the drawings.

### DETAILED DESCRIPTION

The following detailed description of embodiments of the invention references the accompanying figures. The embodiments are intended to describe aspects of the invention in sufficient detail to enable those with ordinary skill in the art to practice the invention. The embodiments of the invention are illustrated by way of example and not by way of limitation. Other embodiments may be utilized and changes may be made without departing from the scope of the claims. The following description is, therefore, not limiting. The scope of the present invention is defined only by the appended claims, along with the full scope of equivalents to which such claims are entitled.

In this description, references to “one embodiment,” “an embodiment,” or “embodiments” mean that the feature or features referred to are included in at least one embodiment of the invention. Separate references to “one embodiment,” “an embodiment,” or “embodiments” in this description do not necessarily refer to the same embodiment and are not mutually exclusive unless so stated. Specifically, a feature, component, action, step, etc. described in one embodiment may also be included in other embodiments, but is not necessarily included. Thus, particular implementations of the present invention can include a variety of combinations and/or integrations of the embodiments described herein.

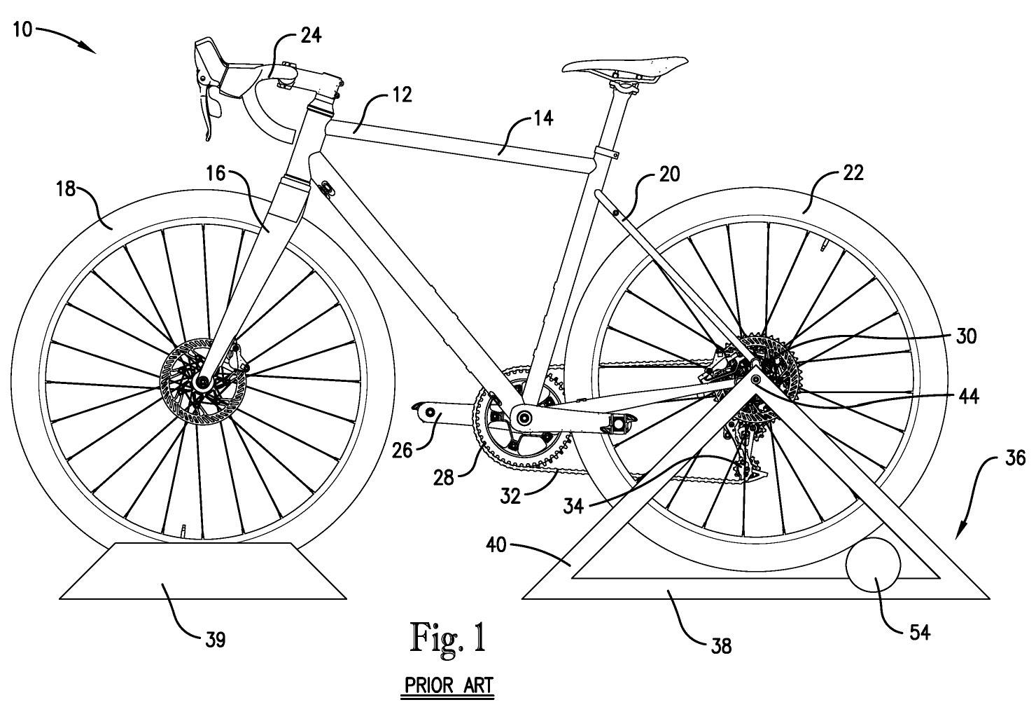

Known bicycle training systems support a bicycle frame and the cyclist generally stationary during a training session while providing resistance to a drivetrain of the bicycle, simulating the resistance applied to the drivetrain during an on-road ride. For example, FIG. 1 shows a prior-art bicycle training system 10. Such training systems 10 typically include a conventional bicycle 12 coupled to a bicycle trainer 36. As should be appreciated, the conventional bicycle 12 generally includes an upstanding frame 14 including a front fork 16 rotatably supporting a front wheel 18 and rear stays 20 rotatably supporting a rear wheel 22. The bicycle 12 also includes handlebars 24 operatively coupled to the front fork 16 that are used to steer the bicycle during use. The handlebars 24 include various controls such as brake levers and, in some embodiments, gear shift levers which may be integral to the brake levers or else separate components therefrom. In other embodiments, the gear shift levers may be mounted elsewhere on the frame 14 such as a downtube, or else may be omitted altogether for single-speed bicycles. When equipped, the brake levers and gear shift levers are operatively connected to brakes and derailleurs, respectively, of the bicycle 12 via a series of cables allowing the user to activate the brakes and shift between gears during a ride.

The bicycle 12 further includes a series of chainrings 28 operatively coupled to a pedal set 26. A chain 32 stretches from one of the chainrings 28 to a rear cassette 30 coupled to the hub of the rear wheel 22, and more particularly to a sprocket of the cassette 30. In this regard, as a cyclist turns the pedal set 26, the chainrings 28 also rotate, which in turn rotates the rear wheel 22 via the chain 32 transmitting the motion to the rear cassette 30, propelling the bicycle 12 forward. The cyclist can shift between chainrings 28 and sprockets on the rear cassette 30 via a front derailleur and rear derailleur 34, respectively, thereby upshifting and downshifting as desired in response to encountering a hill, headwind or tailwind, or other condition.

The bicycle trainer 36 supports the frame 14 in the upright and stationary fashion while allowing the user to crank the pedal set 26 and thus turn the rear wheel 22. More particularly, the bicycle trainer 36 includes a support frame including a base 38 and an upstanding frame member 40. The base 38 rests on a support surface and the upstanding frame member 40 engages a portion of the bicycle frame 14 such as the rear stays 20 of the bicycle frame 14 or a rear axle 44 extending through a hub of the rear wheel 22 in such a manner that the frame 14 is secured in the upright position while the rear wheel 22 is elevated from the support surface. The training system may also include a front dock 39 that holds the front wheel 18, an axle of the front wheel, and/or a front of the frame 14 upright and steady during use of the system.

The bicycle trainer 36 may include a roller 54 or similar mechanism that engages the rear wheel 22 and provides resistance thereto, simulating an on-road riding experience. In some embodiments, the roller 54 may be adjustable to provide varying levels of resistance and thus simulate certain ambient conditions during a virtual ride such as hills, headwinds or tailwinds, varying terrain, or other real-world riding conditions causing a cyclist to downshift or upshift as they would do on the road. Thus, a cyclist using the bicycle training system 10 can train on their bike indoors and is provided a somewhat realistic riding experience notwithstanding that the bicycle 12 remains stationary during use.

However, because the frame 14 and thus the cyclist using the training system 10 is held stationary by the trainer 36 and/or the front dock 39 during use, known training systems 10 fail to provide the cyclist dynamic feedback or an on-the-road feel as the cyclist shifts gears, increases or decreases force on the pedals, or shifts their weight. Moreover, these known training systems 10 may fail to train the proper muscle groups, because the static frame does not require the same cyclist movements and adjustments necessary during on-road riding.

In contrast, aspects of the present invention include a dynamic trainer that moves and reacts to a cyclist’s inputs, thus providing a more accurate on-road feel to the cyclist. The movement of the trainer simulates the natural movement of a bicycle on the road and ensures that the cyclist’s correct muscles are trained. More particularly, at a high level aspects of the invention include a movement platform that provides movement of a bicycle and/or user in multiple axial directions (e.g, left, right, front, back, diagonal, up, down, etc.) and rotational directions, thereby simulating an on-road experience while training a cyclist’s muscles in a similar fashion as outdoor riding.

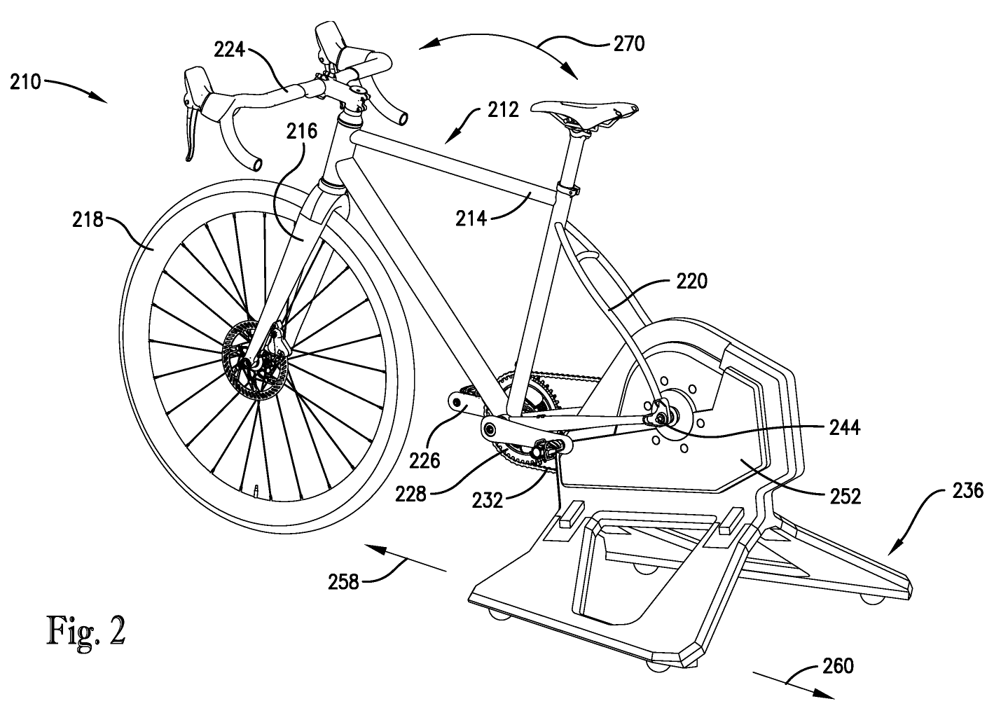

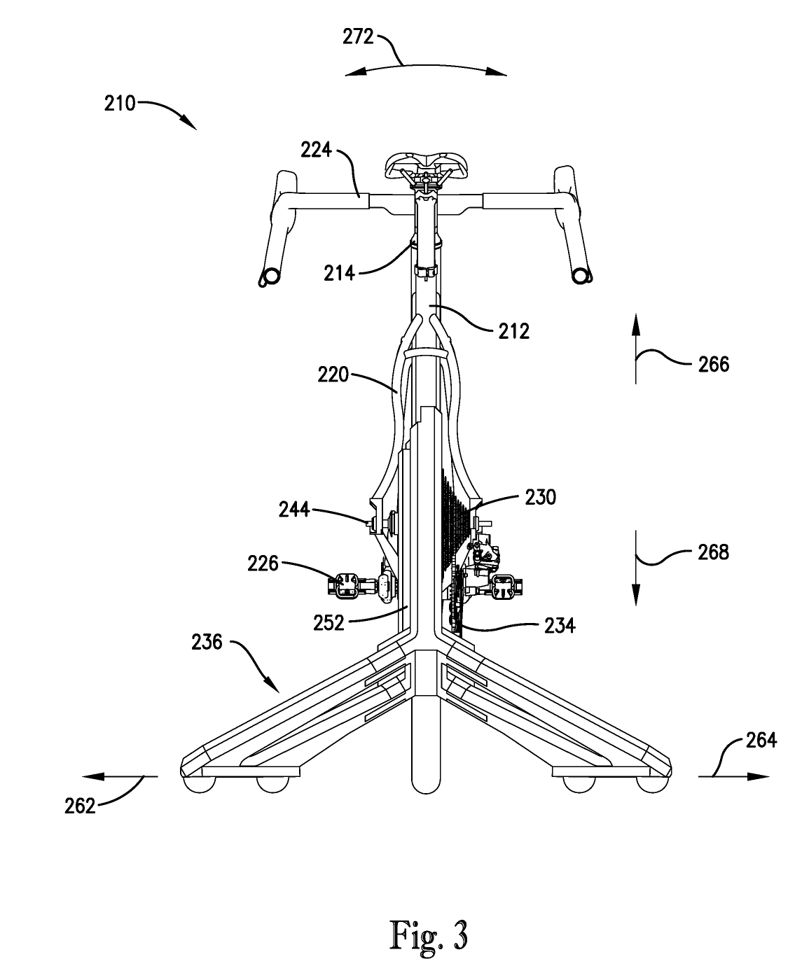

This will be more readily apparent with reference to FIGS. 2 and 3. As shown, embodiments of the present invention include an improved bicycle training system 210. At a high level the bicycle training system 210 includes a bicycle 212 operatively coupled to a movement platform 236, which provides varying levels of resistance to the bicycle 212’s drivetrain during a training session while dynamically responding to the user’s inputs, weight shifts, and other motions by translating and pivoting, replicating an on-road experience.

The bicycle 212 generally includes an upright frame 214 supporting various components such as a front fork 216 rotatably supporting a front wheel 218, rear stays 220 rotatably supporting a rear axle 244, handlebars 224 operatively coupled to the front fork 216, a pedal set 226 coupled to one or more chainrings 228, and a rear cassette 230 (see FIG. 3) driven by the pedal set 226 and chainrings 228 via a chain 232. The rear cassette 230 includes multiple sprockets which selectively receive the chain 232 as a user shifts gears causing a rear derailleur 234 to shift the chain 232 among the sprockets. As such, the bicycle 212 is configured generally the same as bicycle 12, except that the bicycle 212 does not include a rear wheel. Instead, the bicycle 212 is supported at its rear end by its rear axle 244.

The bicycle training system 210 includes the movement platform 236 operatively coupled to a rear portion of the bicycle frame 214 and more particularly to the rear stays 220 and/or the rear axle 244 of the bicycle 212. For example, in the depicted embodiment the movement platform 236 supports the frame 214 via the rear axle 244 of the bicycle 212. In some embodiments, the rear axle 244 may be an integral component of the bicycle 212 and may be, for example, a skewer-type axle or the like. In other embodiments, the rear axle 244 may be an integral component of the movement platform 236 itself. For example, in some embodiments, the training system 210 may incorporate a direct-drive type bicycle trainer. In such a configuration, a portion of the bicycle’s drivetrain (such as the chain and associated rear derailleur) can be connected to an integral cassette provided on the bicycle trainer. In such an embodiment, the rear axle 244 may be part of the movement platform 236.

Although FIGS. 2 and 3 illustrate the bicycle 212 only having a front wheel 218 and no rear wheel, it should be understood that in some embodiments the bicycle 212 may include a rear wheel. In other embodiments, the bicycle 212 may not have either a front wheel or a rear wheel, such as when the training system includes a front dock 39 (see, e.g., FIG. 1) that holds and supports the front of the frame 214.

In any event, the movement platform 236 supports the bicycle frame 214 in an upright manner such that rear axle 244 is permitted to rotate in response to a user’s input on the pedal set 226. In that regard, the movement platform 236 includes a resistance assembly configured to apply varying levels of resistance or force against rotation of the rear axle 244. The resistance assembly 252 generally includes a virtual flywheel or other mechanism configured to engage with the rear axle 244, such that when a cyclist pedals the pedal set 226 the cyclist will feel varying levels of resistance. Alternatively, the resistance assembly 252 may comprise an electric rotor and stator assembly. Regardless, the varying levels of resistance require varying amounts of effort on behalf of the cyclist thus simulating hills, winds, and other conditions attendant with an on-road experience. For example, to simulate a hill or to otherwise increase resistance during a training program, the resistance assembly 252 may increase the rotational resistance to the rear axle 244 by increasing electricity flow to electromagnets of the virtual flywheel and/or rotor and stator assembly.

Other suitable resistance mechanisms may be implemented by the resistance assembly 252 without departing from the scope of the invention. For example, a mechanical braking system could be employed such as a disc or drum brake system, such that brake pads or brake shoes will increase or decrease pressure on the rotating disc or drum to increase or decrease, respectively, rotational resistance. In other embodiments, other types of resistance mechanisms may be employed such as, for example, a mechanical clutch system or the like without departing from the scope of the invention.

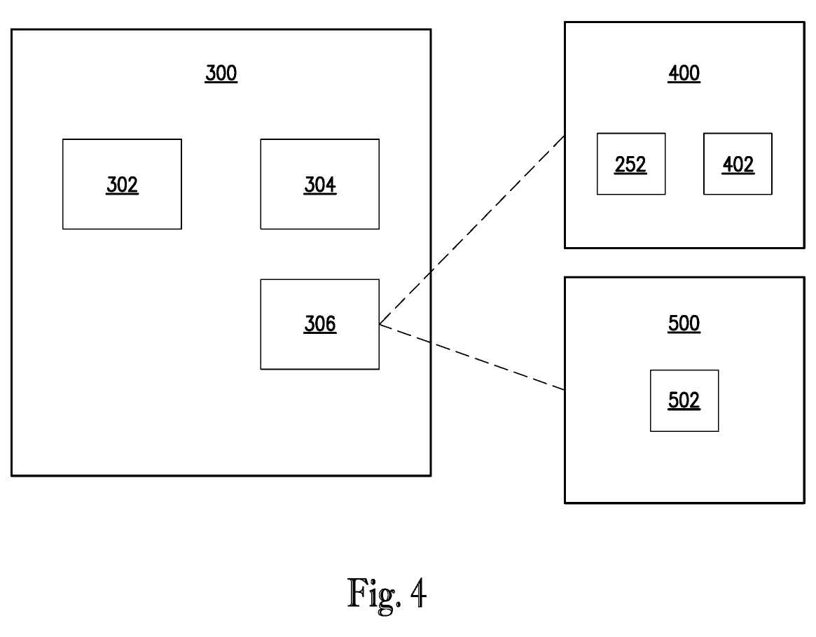

The resistance supplied by the resistance assembly 252 may be controlled via a control system 300 of the training system 210, as illustrated schematically in FIG. 4. The control system 300 may be attached or integrated with the movement platform 236 (or other component of the training system 210) or with the bicycle 212. Alternatively, the control system 300 may be a standalone device, such as an external computing device (e.g., laptop, tablet, smartphone, wearable, etc.).

The control system 300 may comprise an electronic controller that broadly includes one or more processing elements 302, one or more memory elements 304, and/or one or more communication elements 306. The processing element 302 may implement operating systems and may be capable of executing a computer program (which may be stored on the memory element 304), which is also generally known as instructions, commands, software code, executables, applications (“apps”), and the like. The processing element 302 may include processors, microprocessors, microcontrollers, field programmable gate arrays, and the like, or combinations thereof.

The memory element 304 may store the computer program and may also store data, typically binary data, including text, databases, graphics, audio, video, combinations thereof, and the like. The memory element 304 may also be known as a non-transitory “computer-readable storage medium” and may include random access memory (RAM), read only memory (ROM), flash drive memory, floppy disks, hard disk drives, optical storage media, and the like, or combinations thereof. In general, the memory element 304 may be configured to store all of the information described herein, which is used to carry out the methods and processes of embodiments of the present invention. Such methods and processes of the present invention, as described herein, may be performed (at least partly) by the processing element 302 of the control system 300 executing the computer program stored on the memory element 304. In addition to the general data described above, the memory element 304 may be configured to store user data, bicycle trainer data, performance data, and/or routine programs, as will be described in more detail below.

The communication element 306 may be configured to permit the bicycle training system 210 to send/receive data between different components of the bicycle training system 210 (e.g., sensors and/or feedback assembly discussed below), other devices (e.g., external/peripheral devices, graphic displays, etc.), and/or more generally over one or more communications networks. The communication element 306 may include various communication components and functionality including but not limited to: one or more antennas; a transmitter, receiver, and/or transceiver; a wireless radio; data ports; software interfaces and drivers; networking interfaces; data processing components; and so forth. The networks over which the communication element 306 may communicate include various wired and wireless networks, such as a local area network, a wide area network, an intranet, the Internet; a satellite network; a cellular network; a mobile data network; and the like. Specific examples of wireless networks include but are not limited to: networks configured for communications according to: one or more standards of the Institute of Electrical and Electronics Engineers (IEEE), such as 802.11 or 802.16 (Wi-Max) standards; Wi-Fi standards promulgated by the Wi-Fi Alliance; Bluetooth standards promulgated by the Bluetooth Special Interest Group; and so on. Wired communications are also contemplated such as through universal serial bus (USB), Ethernet, serial connections, and so forth.

For example, the communication element 306 may permit the bicycle training system 210 to communicate with a graphic display, which may comprise a LCD (Liquid Crystal Display) display, a TFT (Thin Film Transistor) LCD display, an LEP (Light Emitting Polymer) or PLED (Polymer Light Emitting Diode) display, and/or the like, which is configured to display text and/or graphical information to a user, such as in the form of a graphical user interface (GUI). For example, the bicycle training system 210 may transmit data, via the communication element 306, to the graphic display, such that the graphic display may generate and display simulated visual environments associated with virtual riding routines, which the user can view while the user is using the bicycle training system 210.

The control system 300 may be particularly configured to control a feedback assembly 400 of the bicycle training system 210. The feedback assembly 400 may be configured to apply varying levels of force or resistance to the bicycle 212. For example, the feedback assembly 400 may comprise the resistance assembly 252 discussed above, which is configured to provide varying levels of force or resistance to the drivetrain of the bicycle 212. In addition, the feedback assembly 400 may comprise a movement assembly 402, which is configured to provide varying levels of force or resistance with respect to front-to-back horizontal motion (see arrows 258, 260 of FIG. 2), side-to-side horizontal motion (see arrows 262, 264 in FIG. 3), up-and-down vertical motion (see arrows 266, 268 of FIG. 3) and/or angular motion (see arrows 270, 272 of FIGS. 2 and 3) of the bicycle 212.

The movement assembly 402 may be incorporated with the movement platform 236 of the bicycle training system 210 (or with the front dock 39, if applicable). The movement assembly 402 may comprise various types of actuators, such as electric based linear actuators or dampers, rotary actuators or dampers, or the like. Alternatively, or in addition, the movement assembly 402 may comprise piezoelectric dampers, mechanical dampers, material dampers, or the like. As such, the movement assembly 402 may apply varying levels of force or resistance to motion of the bicycle 212 about multiple axes, including horizontal motion (e.g., side-to-side, front-to-back, or angular motion of the bicycle 212). For example, the movement assembly 402 may impart or restrict side-to-side, front-to-back, or angular motion of the movement platform 236 and, thus, the bicycle 212 and user riding the bicycle 212. Similarly, the movement assembly 402 may apply varying levels of force or resistance to vertical motion of the bicycle 212. For example, the movement assembly 402 may impart or restrict vertical motion of the movement platform 236 (or the front dock 39, if applicable) and, thus, the bicycle 212 and user riding the bicycle 212. Similarly, the movement assembly 402 may apply varying levels of force or resistance to rotational motion of the bicycle 212. For example, the movement assembly 402 may impart or restrict rotational motion (e.g., roll, pitch, yaw) of the movement platform 236 (or the front dock 39, if applicable) and, thus, the bicycle 212 and user riding the bicycle 212. These directions of motion may be considered multiple axes about which the feedback assembly 400 is configured to control the force and/or resistance applied to the bicycle 212.

In certain embodiments, the bicycle training system 210 may additionally or alternatively include a front engagement assembly configured to mechanically interface with a front portion of the bicycle 212, such as the front wheel 218, an axle of the front wheel 218, or front fork 216. The front engagement assembly may be configured to permit, resist, or actively control front‑to‑back and side‑to‑side motion of the front portion of the bicycle relative to the support surface, including by way of one or more mechanical interfaces such as linkages, linear sliders, compliant bushings, elastomeric elements, controlled dampers, or motor-driven actuators. For example, the front engagement assembly may include one or more linkages, sliding interfaces, pivots, dampers, or actuators that enable controlled translational or lateral movement of the front wheel or fork during a training session. Forces applied or resisted at the front engagement assembly may be coordinated with forces applied by the movement assembly 402 and resistance assembly 252 to simulate realistic steering inputs, rider sway, surge motion, or terrain‑induced disturbances, thereby enhancing the fidelity of the simulated on‑road riding experience. The front engagement assembly may be passive, actively actuated, or selectively switchable between passive and active modes.

Control of the feedback assembly 400 may be based on motion information generated by a motion detection system 500 that comprises one or more sensors 502, as discussed in more detail below. In general, such sensors 502 of the motion detection system 500 are configured to detect horizontal, vertical, and/or rotational motion of the movement platform 236, the bicycle 212, and/or of a user of the bicycle training system 210. As such, the sensors 502 are configured to generate motion information based on the detected motion. In certain embodiments, the sensors 502 may be incorporated on or within the bicycle training system 210 (e.g., the movement platform 236 or front dock 39). Alternatively, the sensors 502 may be incorporated on or within the bicycle 212. In embodiments in which the sensors 502 are incorporated on or within the bicycle 212, the sensors 502 may be positioned at various locations of the bicycle 212, such the frame 214, the handlebars 224, the pedal set 226, the seat or the seat post, etc. In further alternatives, the sensors may be incorporated on or within each of the bicycle training system 210 and the bicycle 212.

In certain embodiments, the sensors 502 may comprise at least one accelerometer. In some embodiments, the sensors 502 may comprise three accelerometers configured to detect motion with respect to three orthogonal, spatial axes. For example, each individual accelerometer may be configured to detect motion with respect to a single, spatial axis. In alternative embodiments, the sensors 502 may comprise a single, multi-axis accelerometer configured to detect motion with respect to three orthogonal, spatial axes. In certain embodiments, the at least one accelerometer comprises a micro-electro-mechanical system. In some alternative, or additional embodiments, the sensors 502 may comprise one or more gyroscopes, one or more magnetometers, and/or one or more inertial measurement units (IMUs). In some embodiments, the IMUs include one or more accelerometers and one or more gyroscopes. In some further embodiments, the at least one IMU further includes one or more magnetometers.

In some additional, or alternative embodiments, the sensors 502 may comprise one or more force sensors. In some embodiments, the force sensors may include load cells, strain gauges, pressure sensors, torque sensors, or other devices configured to measure forces, loads, or stresses transmitted through components of the bicycle training system 210 and/or the bicycle 212. Force sensors may be configured to detect rider‑applied forces directly. In certain embodiments, force‑based measurements may be combined with inertial measurements using sensor fusion techniques to improve accuracy, responsiveness, and noise rejection.

In further embodiments, one or more force sensors may be disposed at interfaces between the bicycle training system 210 and the support surface, such as within or beneath the movement platform 236, to detect vertical, longitudinal, and lateral forces transmitted to the ground. Additionally or alternatively, force sensors may be incorporated along one or more load paths between the rider and the support surface, including within drivetrain components such as the pedals of pedal set 26, crank arms, chainrings 228, chain 232, rear axle 244, resistance assembly 252, or associated couplings. By measuring forces transmitted through these components, including longitudinal surge forces transmitted through the drivetrain components, the control system 300 may directly quantify rider‑induced torque, surge forces, or weight transfer events and adjust the feedback assembly 400 accordingly.

In view of the above, the sensors 502 are configured to capture real-time data pertaining to vertical and horizontal movement, pedal force vectors, and rider displacement relative to the frame 214. The bicycle training system 210 (e.g., via the control system 300) then utilizes this information to dynamically adjust the applied resistance across multiple axes (e.g., longitudinal, lateral, vertical), enabling the bicycle training system 210 to replicate force changes associated with climbing surges, inertial fluctuations, and rider-induced torque variations. By capturing and responding to these movements, the bicycle training system 210 creates a more realistic simulation of on-road cycling while also promoting a more effective, body-responsive indoor training experience.

An important consideration in accurately simulating outdoor cycling dynamics lies in differentiating between the motion of the cyclist and that of the bicycle 212 and the bicycle training system 210 (e.g., the movement platform 236 and/or front dock 39). In an actual road cycling environment, the forces acting upon the rider and the bicycle 212 occur in a complex and interdependent manner. However, it is critical to note that the cyclist's body typically represents a significantly greater proportion of the total system mass relative to the bicycle 212 and the bicycle training system 210 hardware. As such, when a training system permits the bicycle and system hardware to move freely—particularly in the longitudinal direction—any forceful motion generated by the rider often results in a reactive, opposite displacement of the lighter bicycle-trainer assembly. This inverse response misrepresents real-world dynamics, where the road provides a fixed reference frame, and the rider’s input primarily results in forward propulsion rather than a shift in bicycle position relative to the ground.

To address this imbalance and better approximate real-world cycling behavior, the embodiments of the present invention are designed to distinguish between rider-induced motion and bicycle training system 210 and/or bicycle 212 motion by independently detecting the dynamic input of the user. Sensors 502 and algorithmic processing are employed by the control system 300 to interpret the origin and direction of forces during the pedal stroke, ensuring that resistance adjustments are based solely on the cyclist’s movement rather than unintended motion artifacts of the hardware components of the bicycle training system 210 (e.g., the movement platform 236 and/or front dock 39). The objective is to replicate the dynamic forces experienced outdoors during each phase of the pedal stroke, taking into account weight shifts, accelerative effort, and inertial fluctuations that naturally arise from the cyclist’s mass and biomechanics. This nuanced approach enables a more faithful simulation of real-world cycling dynamics, improving both the realism and physiological benefit of training sessions.

To deliver a high-fidelity cycling experience, it can be important to accurately measure and respond to the cyclist’s biomechanical inputs in multiple axes (e.g., longitudinal, lateral, vertical). One critical aspect of this is detecting longitudinal, or surge, motion of the user—typically manifested as accelerative or decelerative force along the direction of travel. In embodiments of the present invention, this surge motion is captured through real-time acceleration sensing, which may include sensors 502, such as accelerometers and/or inertial measurement units (IMUs), or other similar sensor arrays positioned on the bicycle 212 (e.g., on the frame 214) or on the bicycle training system 210 (e.g., the movement platform 236 and/or front dock 39). The detected acceleration data is then used to modulate inertial resistance, thereby replicating the feeling of gaining or losing momentum as experienced during outdoor riding scenarios such as sprinting, surging, or braking on a descent.

In addition to longitudinal motion, the bicycle training system 210 monitors vertical or heave motion, which corresponds to the cyclist’s upward and downward movements relative to the bicycle 212. These vertical displacements, often resulting from forceful pedaling efforts or transitions in road gradient, are detected through vertical force measurement mechanisms. Such mechanisms may include sensors 502, such as load cells, pressure sensors, or strain gauges integrated within the trainer assembly. When vertical force increases—such as during a climbing effort or a seated-to-standing transition—the bicycle training system 210 dynamically adjusts incline resistance to reflect the added effort required to overcome gravity. This ensures that the resistance experienced by the rider corresponds not only to the simulated gradient but also to the rider’s real-time interaction with the trainer.

Furthermore, accurate simulation of outdoor riding dynamics necessitates estimation of the rider’s mass. By analyzing sustained vertical force data during static and dynamic phases, the bicycle training system 210 can approximate the effective mass of the cyclist. This information is critical in calibrating incline resistance (to reflect gravitational load), rolling resistance (which is mass-dependent), and inertial resistance (which determines how the system simulates momentum). By factoring in the rider’s mass, the bicycle training system 210 enhances resistance accuracy across various simulated terrains and riding conditions, ensuring that both lighter and heavier riders receive a proportionally realistic training experience.

In advanced embodiments of the bicycle training system 210, vertical force measurements are not only utilized for resistance modulation but also serve as a means for rider identification and profile personalization. By monitoring static vertical load data—typically recorded when the rider mounts the bicycle 212—the bicycle training system 210 can estimate the total mass applied to the trainer. This mass profile, when cross-referenced with stored user data, enables automatic rider recognition. Such recognition facilitates the seamless retrieval of user-specific settings, training history, and performance metrics, thereby personalizing the indoor cycling experience without requiring manual input.

Additionally, the bicycle training system 210 leverages vertical force measurements to estimate the rider's position on the bicycle 212, which in turn informs the aerodynamic profile of the cyclist. As the rider adjusts their posture—shifting from an upright climbing position to a low, aerodynamic tuck, for example—changes in vertical load distribution and contact points can be detected. These variations are interpreted to estimate the rider’s drag coefficient, which influences the simulation of aerodynamic resistance. By dynamically adjusting the aerodynamic model based on real-time rider position, the bicycle training system 210 achieves a more accurate replication of on-road conditions, particularly during time trials or high-speed descents where posture plays a critical role in performance.

To further enhance realism, the bicycle training system 210 integrates vertical and longitudinal force data with acceleration measurements to track both the rider’s and bicycle’s 212 position in three-dimensional space. This data is fed into a virtual reality (VR) or augmented reality (AR) simulation engine, enabling highly accurate replication of the rider's posture, movement, and pedaling dynamics within a visual training environment. As the rider shifts position or transitions between effort levels, the visual model in the virtual environment reflects these changes in near real time, improving immersion and providing valuable feedback on form and technique.

Lastly, by combining acceleration data, vertical force measurements, and crank-based force sensors, the bicycle training system 210 can perform a detailed analysis of cycling efficiency. This includes assessing the symmetry of power output across pedal strokes, evaluating force application timing, and detecting energy losses due to suboptimal movement patterns. The result is a comprehensive efficiency profile that can guide targeted improvements in pedaling technique, weight distribution, and muscle coordination. Such analysis not only benefits competitive cyclists aiming for marginal gains but also supports recreational users in developing a more effective and injury-resistant riding style.

In one exemplary embodiment, the bicycle training system 210 may incorporate sensors 502, such as load cells at each of the movement platform’s 236 contact points with the floor. These distributed load sensors continuously measure the vertical force exerted at each point of contact, allowing for real-time calculation of force distribution beneath the system. By analyzing the relative proportions of load across these measurement nodes, the system is capable of determining the position of the cyclist’s center of mass (CoM) throughout the training session. This positional data, when tracked dynamically, enables the computation or inference of a wide array of performance-related metrics, including rider posture, weight shifts, balance, and pedaling asymmetry. Additionally, the shifting location of the CoM can be correlated with cadence, resistance, and accelerative inputs to assess biomechanical efficiency and stability, providing valuable feedback for both casual users and high-performance athletes.

Another embodiment includes the integration of a sensor 502, in the form of a tilt sensor mounted directly to the movement platform 236 to detect a lean of bicycle training system 210 hardware components and infer rider movement. This approach is traditionally dependent on a combination of adequate frame bending stiffness and a cyclist mass high enough to produce measurable flex in the bicycle training system 210 hardware structure. However, the proposed system design overcomes this limitation by enabling the detection of CoM shifts without requiring significant frame deformation. By capturing subtle changes in tilt angle, the sensor 502 is able to interpret the rider's intention to laterally shift or initiate a maneuver—such as out-of-saddle movement, cornering simulation, or dynamic balance correction—even in the absence of substantial mechanical deflection. This enhanced sensitivity allows for more accurate recognition of rider posture and load distribution, contributing to a more realistic and responsive indoor cycling experience while preserving structural integrity and reducing material fatigue over time.

In addition to load cells and tilt sensors, the bicycle training system 210 can house a range of embedded sensors to detect user motion with minimal setup or intervention. For example, accelerometers and/or inertial measurement units (IMUs) can be integrated directly into the bicycle’s 212 or the movement platform’s 236 chassis to capture acceleration, angular velocity, and lean angles in multiple axes. When mounted near the base or within the movement platform 236 (i.e., the hardware element that houses the flywheel or virtual flywheel), these accelerometers and/or IMUs can measure system response to shifting rider input—such as forward surges, weight transfers, or lateral rocking—without relying on external feedback from the bicycle 212. Similarly, sensors 502, such as strain gauges, can be installed at structural junctions within the bicycle training system 210, such as pivot points or support beams, to detect micro-deflections caused by rider motion. These sensors 502 enable the bicycle training system 210 to distinguish between real-time shifts in rider mass distribution and general bike-trainer motion, allowing for precise resistance adjustments and enhanced biomechanical modeling.

For users utilizing their own bicycles with the bicycle training system 210, the bicycle training system 210 can also support optional add-on sensors that are simple to install and require no permanent modifications. Small clip-on sensors 502, such as accelerometers and/or IMUs, can be attached to common frame points such as the seat post, handlebar stem, or crank arms using quick-release mounts or integrated rubber straps of the bicycles. These portable sensors 502 provide detailed motion tracking—capturing vertical bobbing, handlebar torque, or rider sway—and wirelessly transmit this data to the control system 300 of the bicycle training system 210 for synchronized resistance adaptation. Sensors 502 in the form of pedal-based power meters or axle-mounted torque sensors can further enhance input granularity by offering precise measurements of pedaling force and timing. By offering compatibility with user-friendly, non-invasive add-on sensors, the bicycle training system 210 enables a modular and personalized approach to performance analysis, delivering an advanced training experience without requiring a dedicated or modified indoor bike.

With the integration of acceleration sensors within the bicycle training system 210, the bicycle training system 210 is capable of detecting both the forward surge motion and the lateral lean—or roll—of the rider during a training session. These sensors 502, typically inertial measurement units (IMUs) and/or dedicated accelerometers, capture real-time changes in acceleration and angular orientation along the longitudinal and lateral axes. Forward surge, often occurring during efforts such as sprinting, climbing, or initiating a pedal stroke, is detected as a longitudinal acceleration spike. Simultaneously, rider-induced lean—whether from out-of-saddle climbing or natural upper-body sway—is measured through changes in roll angle. By distinguishing these subtle dynamic cues, the bicycle training system 210 can more accurately simulate corresponding resistive forces such as increased inertia during a sprint or the biomechanical demands of climbing, thereby enhancing the realism and responsiveness of the indoor cycling experience.

The bicycle training system 210 supports detailed aerodynamic profiling by analyzing upper body position and rider movement in real time. Through measurements of subtle shifts in vertical force and rider sway, the bicycle training system 210 can infer changes in posture—such as transitions between upright and aerodynamic tucks. These shifts affect the rider’s effective frontal area and thus alter aerodynamic drag, a critical factor in high-speed and time-trial efforts. By dynamically adjusting the resistance to reflect these aerodynamic changes, the bicycle training system 210 can simulate wind resistance more precisely, reinforcing the rider’s understanding of how body positioning impacts overall performance.

A core benefit of the bicycle training system 210 is its ability to analyze force distribution across the bicycle 212 during dynamic motion. By capturing data on how and where force is applied—such as the balance between the left and right pedals, or shifts in load toward the handlebars during climbs—the system provides valuable insight into a cyclist’s technique and stability. This functionality supports the identification of inefficiencies such as asymmetrical pedaling or excessive upper body movement, which can hinder performance or contribute to overuse injuries. The resulting feedback enables riders to refine their biomechanics and improve power delivery across various terrain simulations.

To further enhance training specificity, the bicycle training system 210 can simulate rider-specific mechanical resistances by leveraging detailed measurements of body mass and CoM movement. These measurements allow the trainer to precisely scale rolling resistance, incline resistance, and inertial loads according to the rider’s unique characteristics. As a result, lighter and heavier riders experience proportionally realistic force profiles that accurately reflect outdoor cycling conditions. This feature is particularly useful for interval training, hill simulations, or performance testing, where even slight variations in resistance can meaningfully impact effort and outcome.

The bicycle training system 210 also supports integration with virtual or augmented reality platforms to provide immersive visual feedback. By combining motion tracking data with real-time rendering, the virtual rider model within the digital environment mirrors the user’s position and movement on the bicycle training system 210. Changes in lean, posture, and effort are reflected instantly within the simulation, allowing users to visually engage with terrain, competitors, or performance metrics in an intuitive and realistic way. This synchronization enhances the rider's spatial awareness and reinforces behavioral adjustments needed for efficient and responsive real-world cycling.

To ensure coherent interpretation of rider motion, the bicycle training system 210 may employ sensor fusion techniques that combine inputs from various sensor 502 types, including force sensors, accelerometers, gyroscopes, and optional crank-based power meters. These inputs can be processed in real time using filtering algorithms and dynamic weighting strategies that help prioritize relevant signals based on context. For example, when vertical force increases alongside forward acceleration, the system can infer whether the rider is climbing or sprinting on flat ground by comparing multiple variables such as lean angle, cadence, and center-of-mass movement. Sensor fusion may also help resolve ambiguous inputs—such as distinguishing between actual rider lean and trainer tilt due to environmental factors—thus improving resistance accuracy and system responsiveness. Over time, the bicycle training system 210 may adapt to individual rider patterns to refine input interpretation and maintain stable, realistic feedback.

To support personalized experiences, the bicycle training system 210 can incorporate user profiles that store individual metrics such as estimated body mass, historical performance data, and motion patterns. Once a rider is recognized—potentially through a static force signature or manual selection—the system may load a corresponding profile and adapt resistance behavior and motion dynamics accordingly. During use, the bicycle training system 210 can collect motion and force data to track changes in technique, identify trends in pedaling efficiency, or detect signs of fatigue. This information may be used to provide adaptive feedback, such as real-time resistance adjustments or post-session analysis, and could also integrate with third-party training platforms to suggest drills or progression strategies. In doing so, the bicycle training system 210 can evolve with the rider, offering insight and guidance tailored to individual training goals.

Prior to active use, the bicycle training system 210 may undergo an initial calibration procedure to ensure accurate measurement of rider-specific parameters and baseline force conditions. This process can begin when the user mounts the bicycle 212 and remains stationary for a brief period, allowing the bicycle training system 210 to establish a zero-load reference across all integrated sensors 502. During this stationary phase, the system may capture the rider’s static vertical load to estimate total mass, balance distribution, and center-of-mass location. In addition, any tilt or acceleration sensors within the trainer can be zeroed relative to the support surface to correct for uneven flooring or minor alignment variances. For systems equipped with crank or pedal-based power meters, baseline torque readings may also be recorded to correct for sensor drift. This calibration sequence may be performed automatically at startup or manually initiated by the user and may be repeated periodically to maintain data integrity throughout extended use or after hardware transport.

In certain embodiments, the bicycle training system 210 is configured to simulate transient traction-loss events that may occur during outdoor riding, such as when a rear tire slips on a wet surface, loose gravel, painted pavement, or other low-friction terrain. More particularly, the control system 300 may receive motion information from the sensors 502 indicative of a rider surge, abrupt lateral shift, rapid acceleration change, and/or other dynamic rider input, and in response may control the feedback assembly 400 to temporarily alter the force and/or resistance applied to the bicycle 212 so as to mimic a momentary loss of traction followed by re-engagement. For example, the feedback assembly 400 may reduce inertial resistance, modify side-to-side and/or front-to-back resistance, or otherwise vary the dynamic response of the movement platform 236 for a brief duration to replicate the feel of wheel slip, washout, or reduced surface grip. In this manner, the bicycle training system 210 may provide a more realistic simulation of outdoor riding conditions while also training the rider to respond to changing traction conditions during a riding session.

We claim:

1. A bicycle training system comprising:
a movement platform configured to rest on a support surface and to support a bicycle in an upright manner with respect to the support surface, wherein the movement platform comprises a feedback assembly configured to apply varying levels of force and/or resistance to the bicycle; and
a motion detection system comprising one or more sensors configured to detect vertical and horizontal motion of at least one of the bicycle, the movement platform, or a user of the bicycle training system, wherein the one or more sensors are configured to generate motion information based on the detected motion; and
an electronic controller configured to receive the motion information from the one or more sensors and to control, based on the motion information, the force and/or resistance applied by the feedback assembly to the bicycle across multiple axes.

2. The bicycle training system of claim 1, wherein the one or more sensors comprise one or more accelerometers.

3. The bicycle training system of claim 2, wherein at least one accelerometer from the one or more accelerometers is configured to detect motion with respect to three orthogonal, spatial axes.

4. The bicycle training system of claim 2, wherein at least one accelerometer from the one or more accelerometers is configured to detect motion with respect to a single, spatial axis.

5. The bicycle training system of claim 1, wherein the one or more sensors comprise one or more force sensors.

6. The bicycle training system of claim 1, wherein the one or more sensors comprise one or more gyroscopes.

7. The bicycle training system of claim 1, wherein the one or more sensors comprise one or more magnetometers.

8. The bicycle training system of claim 1, wherein the one or more sensors comprise one or more inertial measurement units (IMUs), wherein at least one of the one or more IMUs include one or more accelerometers and one or more gyroscopes.

9. The bicycle training system of claim 8, wherein the at least one IMU further includes one or more magnetometers.

10. The bicycle training system of claim 1, wherein the one or more sensors are associated with the movement platform.

11. The bicycle training system of claim 1, wherein the one or more sensors are associated with the bicycle.

12. The bicycle training system of claim 1, wherein the feedback assembly comprises a resistance assembly and/or a movement assembly configured to replicate force changes associated with climbing surges, inertial fluctuations, and user-induced torque variations.

13. The bicycle training system of claim 12, wherein the feedback assembly comprises a resistance assembly configured to be operatively coupled with a portion of a drivetrain of the bicycle and to apply varying levels of resistance to the portion of the drivetrain.

14. The bicycle training system of claim 12, wherein the feedback assembly comprises a movement assembly associated with the movement platform and configured to apply varying levels of force or resistance with respect to side-to-side and/or front-to-back motion of the bicycle.

15. The bicycle training system of claim 14, wherein the movement assembly is configured to apply varying levels of force or resistance with respect to side-to-side and/or front-to-back motion of the bicycle to replicate the feeling of the user gaining or losing momentum with the bicycle.

16. The bicycle training system of claim 12, wherein the feedback assembly comprises a movement assembly associated with the movement platform and configured to apply varying levels of force or resistance with respect to angular motion of the bicycle.

17. The bicycle training system of claim 16, wherein the movement assembly is configured to apply varying levels of force or resistance to replicate additional effort required by the user to overcome gravity during a climbing effort or a seated-to-standing transition.

18. The bicycle training system of claim 1, wherein the movement platform is configured to support bicycles having no rear wheels.

19. A method of training using a bicycle training system comprising:
providing the bicycle training system comprising a movement platform positionable on a support surface;
supporting, with the movement platform, a bicycle in an upright manner with respect to the support surface, wherein the movement platform comprises a feedback assembly configured to apply varying levels of force and/or resistance to the bicycle;
detecting, with a motion detection system comprising one or more sensors, motion of the bicycle, motion of the movement platform, and/or motion of a user of the bicycle training system;
generating, with the one or more sensors, motion information based on the detected motion;
receiving, via an electronic controller, the motion information from the one or more sensors; and
controlling, with the electronic controller based on the motion information, the force and/or resistance applied by the feedback assembly to the bicycle.

20. The method of claim 19, wherein the feedback assembly comprises a resistance assembly and/or a movement assembly configured to replicate force changes associated with climbing surges, inertial fluctuations, and user-induced torque variations.
